(19) United States
(12) Patent Application Publication
(10) Pub. No.: US 2003/0195802 A1
(43) Pub. Date: Oct. 16, 2003

(54) System and method for managing a distributed branding program and creating advertisements

(76) Inventors: Kelly P. Hensen, Chicago, IL (US); Rick Lattanzio, Bloomingdale, IL (US)

Correspondence Address: Bell, Boyd & Lloyd LLC, P.O. Box 1135, Chicago, IL, 60690-1135, US

(21) Appl. No.: 10/123,360

(22) Filed: Apr. 15, 2002

(51) Int. Cl. G06F 17/60

(52) U.S. Cl. 705/14

(57) ABSTRACT

The present invention provides both a method and system for managing a Distributed Branding Program and a method and system for creating marketing materials in compliance with such a Distributed Branding Program. The invention further provides a dynamic web page for creating advertisements and marketing materials in an on-line environment wherein the resulting advertisements and marketing materials comply with the guidelines of a Distributed Branding Program.

### BACKGROUND OF THE INVENTION

The present invention provides a system and method for managing a Distributed Branding Program, as well as a system, method and application for generating advertisements or other marketing materials within such a Distributed Branding Program.

Distributed Branding may include a range of business practices like cooperative advertising accrual and reimbursement programs, franchise contract agreements, or sales distribution contracts. For example, in a typical cooperative advertising program, a manufacturer, distributor or some other commercial entity that brings its products to market via a network of independent or semi-independent Dealers, agrees to help fund the Dealer's marketing efforts for the sale of its products. In another example, franchise contract agreements, the commercial entities license the use of things like its distributor network and business model to independent entrepreneurs. Since one of the elements that these independent business people is selling is the Brand of the franchise, agreements are made and processes are instituted that limit and direct the use of brand capital elements by the franchisees.

In all instances of Distributed Branding Programs, the business entity whose products and services are being advertised and sold (hereafter, the Company) will usually desire to control the quality and content of the advertising in order to control the image of the Company and its products and services that are presented to its consumers. In most cases, however, it is the individual Dealers, franchisees or sales representatives (hereafter, Dealers) who are responsible for producing their own marketing materials and advertisements. In order to exert control over the materials produced, the Company may condition its contracts or its reimbursement of the Dealer's advertising efforts on the requirement that strict guidelines are followed as to the form, content and production of the Dealer's advertisements or marketing materials.

In the past this has required the development of extensive agreements in which the brand and advertising guidelines, rules and content—including approved product photos, copy, campaign slogans, layouts, trademark placement and sizes, approved fulfillment vendors and so forth—are all painstakingly spelled out. By requiring the Dealer to adhere to such rules and regulations in order to qualify for reimbursement of advertising expenses or to continue to represent and sell the products and services of the Company, the Company can control the manner in which its products and services are presented.

To facilitate the production of marketing materials that comply with the Distributed Branding Program guidelines, the Company may supply elements such as “Slick Books” or “Tear Sheets” that include pre-approved materials that comply with the brand guidelines and the contractual terms of the advertising agreement. These materials will typically include suggested layouts, product photographs, preprinted advertising slogans, pricing and special offer information, required disclaimers, product descriptions, and the like, for the production of marketing pieces such as newspaper advertisements, direct mail pieces, or point of sale signage. In creating a marketing piece, the Dealer may select a particular layout and then may select the various components that are pre-approved to be placed within various predefined locations designated on the layout sheet. In the past, creating marketing materials in this manner literally involved cutting and pasting the various components from the pre-printed materials onto a template or layout sheet.

A complicating factor in managing a Company's Distributed Branding Program is the number and types of different Dealers involved in the program. The guidelines covering the Distributed Branding Program may be influenced by factors such as a Dealer's sales volume, geographic location, or the product lines carried. For example, a well known Dealer that has stronger negotiating power vis-à-vis the Company may be allowed greater flexibility in displaying the Company's products and his/her logos than a smaller Dealer with less negotiating power. Dealers located in different jurisdictions may be subject to different government regulations and may be required to include different disclaimers within their advertising materials. This may also affect the terms of the Distributed Branding Agreement with a Dealer. All of these factors must be considered when developing the Distributed Branding guidelines and materials for individual Dealers.

A prior approval provision may also be part of a Distributed Branding program. Under such a provision the Dealer may be required to submit a proposed advertisement or piece of marketing collateral to the Company or its Distributed Branding Program representative or management agent prior to its use. Failure to obtain prior approval may result in the Company withholding compensation for the associated printing, production or media placement fees or may put the Dealer's branding and advertising contractual obligations in jeopardy. In order to obtain prior approval, the preliminary artwork, production specifications and intended usage must be submitted to the Company, a process that sometimes causes deadlines to be missed. Upon receiving prior approval, the artwork must then be prepared as final art and sent to the publisher or printer. Again, this process consumes time and requires the physical transport of the artwork from the person who created it to the entity that will handle fulfillment (the publisher or printer, for example).

In light of this background, a system for improving the efficiency of managing a Distributed Branding Program and for streamlining the process of producing marketing materials in compliance with a Distributed Branding Program is desired. Such a system should be flexible such that differing guidelines can be applied to different Dealers having Distributed Branding Agreements with a given Company. Further, such a system should be configured such that marketing materials created by a Dealer using the system will inherently comply with the branding and advertising agreement guidelines applicable to that particular Dealer. An additional feature that would be desirable in a system for managing a Distributed Branding Program is that the artwork created by the system should be rendered in an electronic format so that the files may be electronically transmitted over a computer network to the various entities involved in the creation, approval, production or placement of the materials. With this feature, preliminary ad layouts may be electronically submitted to the Company for prior approval, to an advertising agency for editing, or directly to a printer or publisher for fulfillment.

### SUMMARY OF THE INVENTION

The present invention provides both a method and system for managing a Distributed Branding Program and a method and system for creating marketing materials in compliance with such a Distributed Branding a program. The invention further provides a dynamic web application for creating advertisements and marketing materials where the resulting artwork complies with the guidelines of a Distributed Branding Program.

In an embodiment of the invention, a system for managing a Distributed Branding Program is provided. The system includes a number of templates and assets stored in a database. The templates include Asset Display Locations that are configured to receive and display selected assets. An application server is provided which is configured to retrieve the templates and assets from the database. The application server communicates with a user terminal over a computer network to selectively display the templates and assets in response to user input entered at the user terminal.

In another embodiment of the invention a method of managing a Distributed Branding Program is provided. The method includes storing a plurality of assets such as product photographs, advertising slogans, logos and the like in a database. Another step involves creating a template from which future marketing materials may be created. The template is created having one or more predefined areas (hereafter, Asset Display Locations) that may be edited by a user. The type of information the user may edit defines Asset Display Location's type. Asset Asset Display Locations allow the user to select from a menu of assets that are made available based on that user's permissions and the assets associated with the template and Asset Display Location. Text Asset Display Locations may be edited by the user entering information into an open text field. Text Asset Display Locations may also be pre-populated with information from the database associated to the user. In the case of pre-populated Text Asset Display Locations, the user may or may not be able to edit the information dynamically populated into these Asset Display Locations, depending on the rules assigned to those Asset Display Locations. . In the case of Asset Asset Display Locations, the method further involves forming associations between the various assets and the Asset Display Locations of the template. Marketing materials are created by individually selecting each Asset Display Location of the template and selecting an asset from among a group of assets associated with each Asset Display Location for display within the respective Asset Display Locations. The group of assets from which a selected asset is chosen is formed of those assets having an association with the particular Asset Display Location and template selected as well as the permissions of the user manipulating the template. As explained below in more detail, the group of assets displayed may also be based on dependencies tied to the assets selected in other Asset Display Locations. Once an asset has been selected, an image of the selected asset appears in the Asset Display Location for which the asset was chosen. In this way, marketing artwork is created based on the format of the template. When the template, the assets, and the associations between the Asset Display Locations and assets are created in accordance with the Distributed Branding Agreement guidelines, the resulting artwork necessarily conforms to the guidelines as well.

In yet another embodiment of the invention, a system for creating marketing materials is provided. The system includes an application server for receiving input from and displaying information on a user terminal via a network. A database is provided having a number of templates and assets stored therein. User information is also stored for the purposes of tying permissions to templates and assets and for pre-populating Dealer-specific information within the template. The templates define Asset Display Locations for receiving and displaying assets. Each Asset Display Location has at least one asset associated with it or is configured such that a user may enter text characters to be displayed within the Asset Display Location. The application server retrieves a template from the database in response to commands entered by a user at the user terminal. Upon retrieving the desired template from the database, the application server transmits the template via the network to the user terminal where it is displayed by the user's web browser. The application server receives input from the user terminal indicating that a particular one of the Asset Display Locations has been selected, and retrieves the assets stored in the database that are associated with the selected Asset Display Location and user permissions. In lieu of predetermined text or graphics, assets may alternatively comprise open text or database populated text boxes. Such Asset Display Locations include attributes that govern the display of user-defined text or default text values supplied by the database within the selected Asset Display Location. Upon receiving the appropriate assets or text box information, the application server forwards the data via the network to the user terminal where they are displayed. The application server receives an indication from the user terminal when the user selects one of the displayed assets or when the user enters a particular text string. Upon receiving such an indication the application server, in conjunction with the data stored in the database, causes the user terminal to display the selected asset or text string within the selected Asset Display Location. Finally, the application server is configured to electronically render artwork based on the completed template upon receiving a rendering command from the user terminal.

In still another embodiment of the invention, a method for creating marketing materials is provided which facilitates the creation of marketing pieces that comply with the guidelines of a Distributed Branding Program. This method includes the steps of selecting a template having one or more Asset Display Locations. After selecting a template, a user selects one of the one or more Asset Display Locations within the template. The next step involves selecting an asset from a group of assets associated with the selected Asset Display Location and displaying the selected asset in the template in the area corresponding to the selected Asset Display Location. Once the ad is complete and an asset has been selected (or text has been retrieved and/or entered) for each Asset Display Location, the final step involves electronically rendering the artwork based on the selected template and the selected assets.

Yet another embodiment of the invention provides an application for providing dynamic web pages to a user terminal for creating marketing materials that meet guidelines established in a Distributed Branding Agreement. The dynamic web page is adapted to be displayed on a computer output device by an Internet web browser. The dynamic web page includes a Template Display Area and a template to be displayed within the Template Display Area. The template includes one or more Asset Display Locations for receiving and displaying selectable advertising content. An Asset Display Area is also included in the dynamic web page for displaying selectable advertising content in the form of individual selectable assets or text fields associated with a particular Asset Display Location that has been selected within an active template. The interface for selecting assets or entering/editing text that is displayed in the Asset Display Area changes according to the type and properties of the Asset Display Location selected. Finally, when an asset is selected from the Asset Display Area, an image of the selected asset or the text that has been entered by the user is displayed in the Template Display Area in a position corresponding to the selected Asset Display Location.

Additional features and advantages of the present invention are described in, and will be apparent from, the following Detailed Description of the Invention and the figures.

### BRIEF DESCRIPTION OF THE FIGURES

FIG. 1 is a schematic representation of an advertisement created in accordance with a Distributed Branding Agreement;

FIG. 2 is a block diagram of a system for managing a Distributed Branding Program and creating marketing materials in compliance with such a program;

FIG. 3 is schematic representation of a software stack of an animation software package;

FIG. 4 is a representation of a dynamic web page according to the present invention;

FIG. 5 is a representation of the dynamic web page of FIG. 4 having a template displayed in a Template Display Area and a plurality of assets displayed in an Asset Display Area corresponding to the selection of a first Asset Display Location;

FIG. 6 is a representation of the dynamic web page of FIG. 4 showing the same template as FIG. 5, but with a first asset selected for display within a first Asset Display Location, and with a different set of assets displayed in the Asset Display Area corresponding to the selection of a second Asset Display Location;

FIG. 7 is a representation of the dynamic web page of FIG. 4, showing the same advertisement template as FIGS. 5 and 6, but with a second asset selected for display in the first Asset Display Location, and a set of Assets Displayed in the Asset Display Area corresponding to the selection of the second Asset Display Location wherein the assets available for display in the second Asset Display Location are dependent on the asset selected for display in the first Asset Display Location;

FIGS. 8a, 8b, 8c and 8d show various options available on a page options menu.

FIGS. 9a and 9b are a flow chart depicting an ad approval process.

### DETAILED DESCRIPTION OF THE INVENTION

A first embodiment of the invention provides a system for managing Distributed Branding Programs. According to this aspect of the invention, templates tailored to specific Dealers with which a Company has a Distributed Branding Agreement are stored in a database. Templates can be created to be accessed by all Dealers, groups of Dealers or only one specific Dealer. The system provides assets to be used in conjunction with the templates in order to create Dealer marketing materials that simultaneously advertise both the Dealer and the Company's products and services. There are three ways to access templates. One is by creating a new template. Another is by accessing Active templates. Active templates are those that have been saved but are not yet completed or that are in the pending approval process. The final way to access templates is through History or Templates that have been developed, approved and downloaded or sent to a fulfillment vendor. When an historical template is selected, it is displayed in view-only mode. In order for the user to manipulate historical templates, the user must save the template under a new name. The act of saving the template will check all of the Asset Display Locations and associated assets to see if any assets have expired. If assets have expired, those Asset Display Areas are reset to gray boxes; otherwise the content selected or entered in the historical template is displayed in the template edit screen. All discussion below of template manipulation can be applied to templates accessed from any of these three sources.

As will be described in more detail below, the templates and assets are stored in the database and are organized and identified in a manner that allows each Dealer to access only those templates and assets that the Company approves for use by each respective Dealer. Thus, the Company may control the templates and assets available for use in a Dealer's marketing pieces consistent with the guidelines established for each individual Dealer participating in the program. A user associated with a Dealer can create personalized materials using the templates and assets stored in the database and accessible to the user. In this case, because the templates and assets available to the user are limited to those that comply with the terms of the Distributed Branding Agreement between the Dealer and the Company, the final artwork created by the system will necessarily also comply. If the Company requires all of its participating Dealers to use the system, the Company can be assured that each of its Dealers are producing marketing materials that comply with their respective Distributed Branding Agreements. The system also provides a mechanism whereby artwork may be reviewed by the Company or an agent designated by the Company using the back-end interface for approval prior to final production. In the case of templates with large open text areas, the approval process can make sure more flexible templates also comply. By implementing the automated prior approval feature, Dealers are given greater flexibility to create marketing materials based on their own designs and customized templates while the Company maintains control over its Distributed Branding Program.

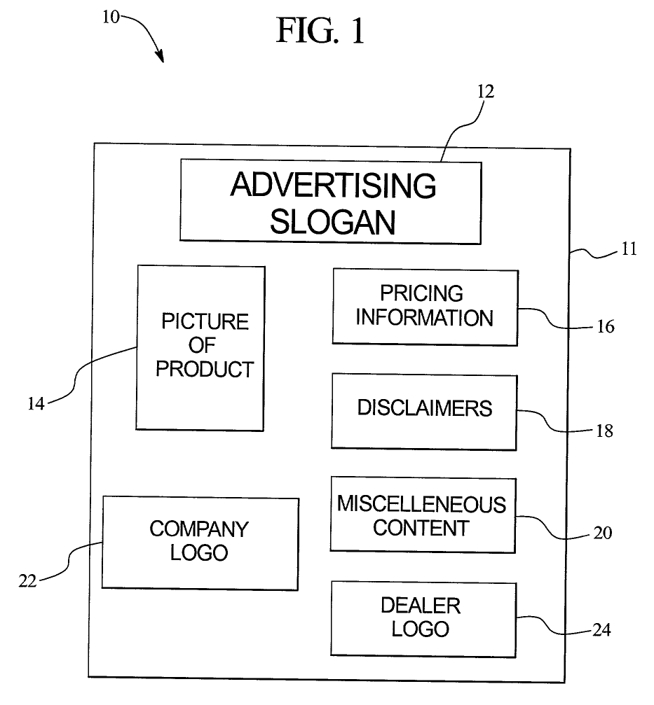

FIG. 1 shows an example of a printed ad 10 created by the system of the present invention. The advertisement 10 includes a defined border 11 and a number of distinct copy elements or assets including an advertising slogan 12, a product picture 14, pricing information 16, disclaimers 18, miscellaneous other content 20, a Company logo 22, and a Dealer logo 24. According to the system of the present invention, the content available to be displayed in the various Asset Display Locations, may be graphic assets such as photos, logos, maps and so forth, or may be text assets where the dealer can edit content into an open text field or may be text pre-populated from the database based on the permissions and associations established by the user. Depending on the established permission that the user may or may not be allowed to edit pre-populated text assets. In either case, the contents of the Asset Display Locations is limited to content that has been pre-approved and complies with the guidelines established according to the Distributed Branding Agreement.

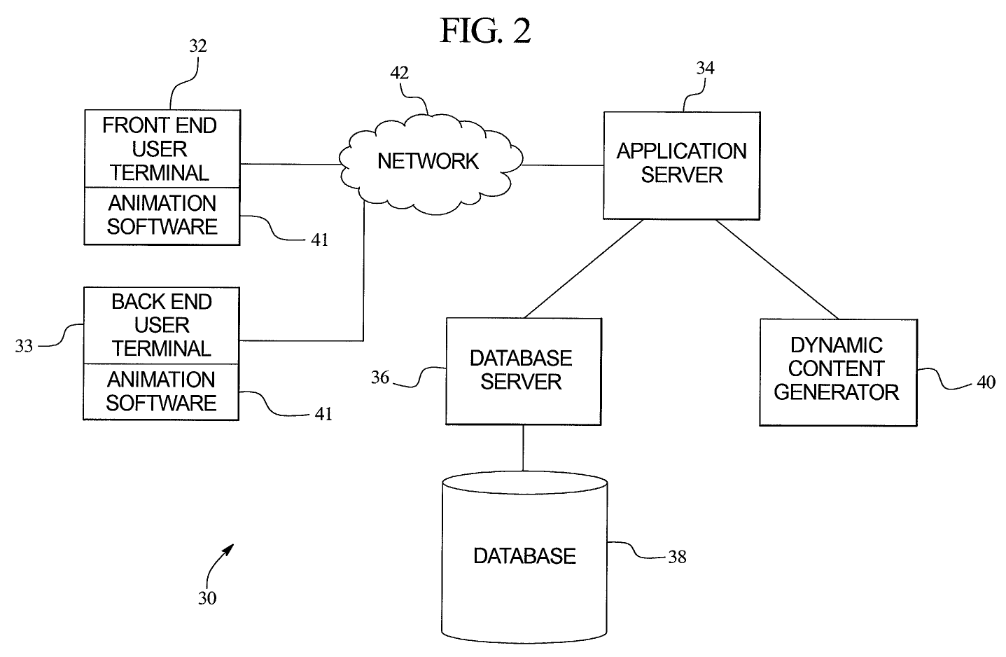

FIG. 2 shows a block diagram of the major components of a Distributed Branding management system 30 according to the present invention. The system includes a Dealer or front-end user terminal 32, a Company or back-end user terminal 33, an application server 34, a database server 36, a database 38, and an animation content generator 40. The front-end and back-end user terminal 32, 33 include an animation software package 41 such as Flash™ from Macromedia, Inc. of San Francisco, Calif. The content generator 40 may also be a Macromedia, Inc. product known as Generator™ or a Macromedia, Inc. product known as Cold Fusion. The animation software displays dynamic content within web pages that are stored on the application server 34 or content generator server 40 and which may be transmitted to the front-end or back-end user terminals 32, 33. These dynamic web pages allow a user to interact with the system 30 and create marketing materials in a quick and efficient manner. The unique way in which the database server 36, the application server 34, the animation content generator 40, and the animation software interact 41 allows advertising content to be quickly retrieved from the database 38, displayed, and manipulated at the front-end and back-end user terminals 32, 33.

While the application server 34, and the animation content generator 40 are conceptually distinct, it is possible that they may be run on a single computer platform. The user terminal 32 may be a common personal computer running a network web browser program. In order to access the system 30, the web browser running on the front-end and back-end user terminals 32 must be equivalent to or compatible with Internet Explorer™ 5.0 or later release with the Macromedia Flash™ 5.0 or later release plug-in. The front-end and back-end user terminals 32, 33 interface with the application server 34 via a computer network 42 such as the Internet.

In general, there will be three classes of users of the system 30: Dealer users, Company users and third party users designated by the Company and its Dealers. Although back-end users may create or edit templates on behalf of Dealers, more often the users associated with Dealers will use the system 30 to create and edit marketing materials. Therefore, the portion of the system facing the Dealers is generally considered the system “front-end” and users associated with Dealers will be referred to as front-end users. Users associated with the Company whose Distributed Branding Program is managed by the system 30 will be referred to as back-end users. Other users will be designated third party users and will most often use a modification of the front-end user's interface. Their relationships to the Company and/or Dealers will be indicated as necessary. The system components necessary to provide dynamic content to the front-end user terminal 32 and produce finalized marketing materials will be referred to collectively as back-end systems.

Back-end users will generally be using the system 30 to manage templates, assets, users, and the relationships between the various users. It will be the responsibility of Company users (or designees of the Company accessing the system via a back-end user terminal) to create templates, post assets to the system, and define the relationships between the templates, assets and the various rules to be applied to the different Dealer users. Back-end users may also have permissions to create and edit templates on behalf of a Dealer. A back-end user associated with a Company employing the system 30 to manage its Distributed Branding Program accesses the system 30 over the computer network 42 via the back-end user terminal 33. The application server 34 sends a login page to the back-end terminal 33 that prompts the back-end user to enter a username and password. The user's username name and password are then sent back to the application server over the network. Once the username and password are confirmed the application server 34 generates and transmits a dynamic web page to be displayed on the back-end user terminal 33 by the back-end user's web browser. The dynamic web page allows the back-end user to access the database 38 and create and edit templates and store assets that may be used to populate the templates when front-end users access the system 30 to create their own marketing materials.

The web page displayed on the back-end user terminal presents an interface by which the back-end user can manage the Distributed Branding Program. This interface allows the back-end user to add, edit or remove the front-end users who will have access to the Company's marketing materials. The interface also allows the back-end user to define which templates and assets will be available to the various front-end users. The interface further allows the back-end user to establish the relationships between the Company, the front-end users, and various third parties such as printers, publications, ad agencies and the like. The system also allows the back-end user to define which assets are available for use with various templates, and where within the templates the assets may be placed. The back-end user may also establish start and end dates between which the various templates are available. In this way, the system allows the back-end user to control the templates and assets that are available to each Dealer participating in the distributed branding program and determine an appropriate approval procedure for templates. Based on settings selected by the back-end user, pre-approval of artwork created from the templates may be required optional or not be available at all.

A front-end user associated with a dealer or a third party user designated by the company or a dealer desiring to create marketing materials using system 30, contacts the application server 34 over the computer network 42 from a front-end user terminal 32. Similarly a back-end user may contact the system 30 over network 42 via back-end user terminal 33 in order to create and edit templates, post assets, and generally manage the distributed branding program. The application server 34 responds by transmitting a login page to the front-end and back-end user terminal 32, 33. The login page is displayed on the front-end or back-end user terminal 32, 33 by the terminal's web browser. The login page includes fields for receiving a username and password entered by the user to sign on to the system 30. After the user has entered the appropriate username and password, the login data are transmitted to the application server 34, which verifies the login data against username and password data stored in the database 38. The username and password data stored in the database 38 are associated with a particular user associated with either the Company, a particular Dealer which has a relationship with the Company or a third party designated by the Company or one of the Company's Dealers. When a front-end user logs in, for example, the templates and assets available are limited to those available to the individual Dealer with whom the front-end user is associated. The available templates and assets may be further limited to individual users if desired.

Once the application server 34 has determined the front-end or back-end user's identity, the application server begins to pull data from the database 38 specific to the resources (Company or Dealer, for example) with which the user is associated. The data pulled from the database 38 are routed by the database server 36 or the content generator server 40 to the application server 34 and are used to populate the various dynamic web pages that are to be transmitted from the application server 34 to the front-end or back-end user terminal 32 or 33. The details of operation of the “back-end” systems, namely the application server, the database server 36 and database 38, and the animation content generator 40 will be discussed in more detail below. However, for the present discussion of the front-end operation of the system 30, it is sufficient merely to know that the application server 34 can access the various data repositories in order to locate, retrieve, and store data as needed to dynamically produce the web pages that are displayed by the user's web browser as the user employs the system 30 to create marketing materials.

Among the data stored in the database 38 are individual templates. These templates represent blank, predefined layouts that can be used to create new marketing materials. When a particular front-end user logs onto the system 30 the application server 34 transmits a list of templates available to that front-end user. Since the templates are pre-defined in accordance with the Distributed Branding Agreement guidelines and because the application server 34 is able to determine which templates are available to specific front-end users, the system 30 ensures that marketing pieces created by specific front-end users conform to the appropriate guidelines.

In addition to a list of available templates, the application server may also send a list of marketing pieces previously created by the front-end user or other users associated with the same Dealer. Such previously created marketing pieces may be stored as active pieces which are currently in the process of being created, or historical pieces which have been completed previously. These active and historical pieces are made available to the front-end user for copying, editing, and the like. The system 30 may also provide a library of assets that the front-end user may access and use to create marketing materials independently of any predefined templates. However, because the templates have been created in strict accord with the guidelines established between the Company the Dealer, marketing materials created using the templates will necessarily comply with the guidelines, whereas independently created artwork may not. By allowing front-end users to create their own artwork independently of the predefined templates, greater flexibility is provided to the Dealers. However, by requiring prior approval of such freelance artwork, the Company can still maintain control of the Distributed Branding Program.

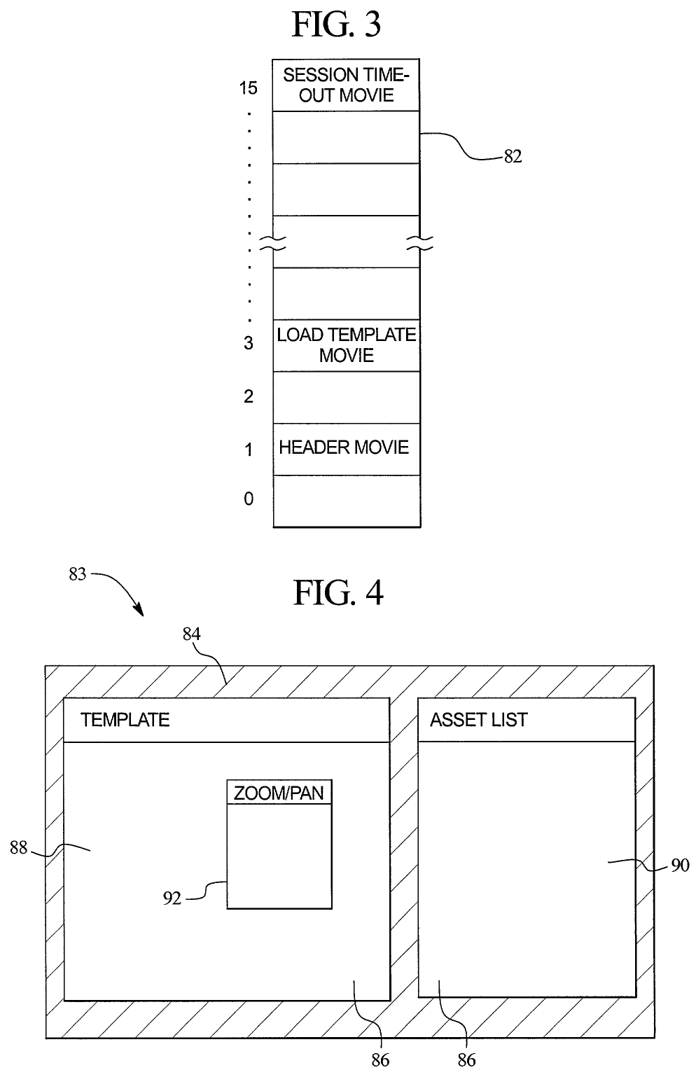

FIG. 4 shows an example of a dynamic web page 83 created by the system 30 for display on the user terminal 32 or 33. The dynamic web page 83 includes a Template Display Area 88 and an Asset Display Area 90, as well as a zoom/pan window 92.

FIG. 5 shows the dynamic web page 83 of FIG. 4 with a template 94 displayed in the Template Display Area 88. The template 94 defines a bordered space representing a predetermined marketing piece, such as, for example, a ¼ page newspaper advertisement, a postcard for a direct mail campaign, a brochure, a sell sheet, or the like. A number of Asset Display Locations 96, 98, 100, 102, 104 106 and 108 are embedded within the template 94. The Asset Display Locations 96-108 act as placeholders for receiving marketing content such as text, or graphical information such as pictures, logos, maps, and so forth. The template 94, including the Asset Display Locations, the size and position of the Asset Display Locations, as well as the content that may be placed in each Asset Display Location is created by a user associated with the Company in accordance with the controls the Company desires to exert over its Distributed Branding Program. Depending on the associations developed by the template's creator, some Asset Display Locations may be configured as open text Asset Display Locations in which a user is free to enter text of his or her choosing to be displayed within the Asset Display Location. Still others may be configured as database populated text Asset Display Locations. These Asset Display Locations will be populated with text values stored in the database associated with the Dealer with whom the user is associated. For example, a database-populated text Asset Display Location may include a field such as “Dealer name.” In this case, the field will automatically be filled with the name of the Dealer in the database with which the user is associated. This information may be pulled from the database based on the user's username name. Some such pre-populated fields may be formatted to allow the user to overwrite the data displayed or may be formatted to disallow editing by the user. If the database fields in the database that determine the contents of the dynamically populated asset to display locations are blank, the user may be allowed to enter additional, new data into these Asset Display Locations. Further, some assets or Asset Display Locations may be configured as hybrids in which the user may select from predefined assets to be displayed or may enter text into the Asset Display Location.

The Asset Display Area 90 provides a menu of assets that may be selected for display within a selected Asset Display Location. When the front-end user selects one of the Asset Asset Display Locations 96-108, by, for example, mouse clicking a desired Asset Display Location, various content elements or assets are displayed in the Asset Display Area 90. Or, if the user selected a Text Asset Display Location, a text input window is displayed in the Asset Display area 90. If a hybrid Asset Display Location is selected both a text window and a list of available assets appear in the Asset Display Area 90. The assets displayed in the Asset Display Area 90 are typically reduced size and reduced resolution images of the actual assets themselves, be they photographs, text, logos and so forth. These smaller, low-resolution images may be referred to as thumbnail displays. When an Asset Display Location is selected, its color on the display or some other visual characteristic will change in order to distinguish it from other non-selected Asset Display Locations. In the example of FIG. 5, the crosshatched area corresponding to Asset Display Location 96 indicates that Asset Display Location 96 has been selected. Thumbnail displays of Assets 110, 112, 114, and 116 are displayed in the Asset Display Area 90. These represent the group of assets from which an asset may be selected for display within the Asset Display Location 96. In the example, the thumbnail displays correspond to medium assets for first, second, third, and fourth advertising slogans 110, 112, 114, and 116, one of which may be selected to fill the Asset Display Location 96. The front-end user selects an asset to be displayed at the selected Asset Display Location by mouse clicking on the desired thumbnail asset. Once an asset is selected for display in the Asset Display Location, a medium resolution image of the asset is displayed in the template in the area corresponding to the selected Asset Display Location. A complete discussion of thumbnail, medium and final resolution files associated to assets is given below.

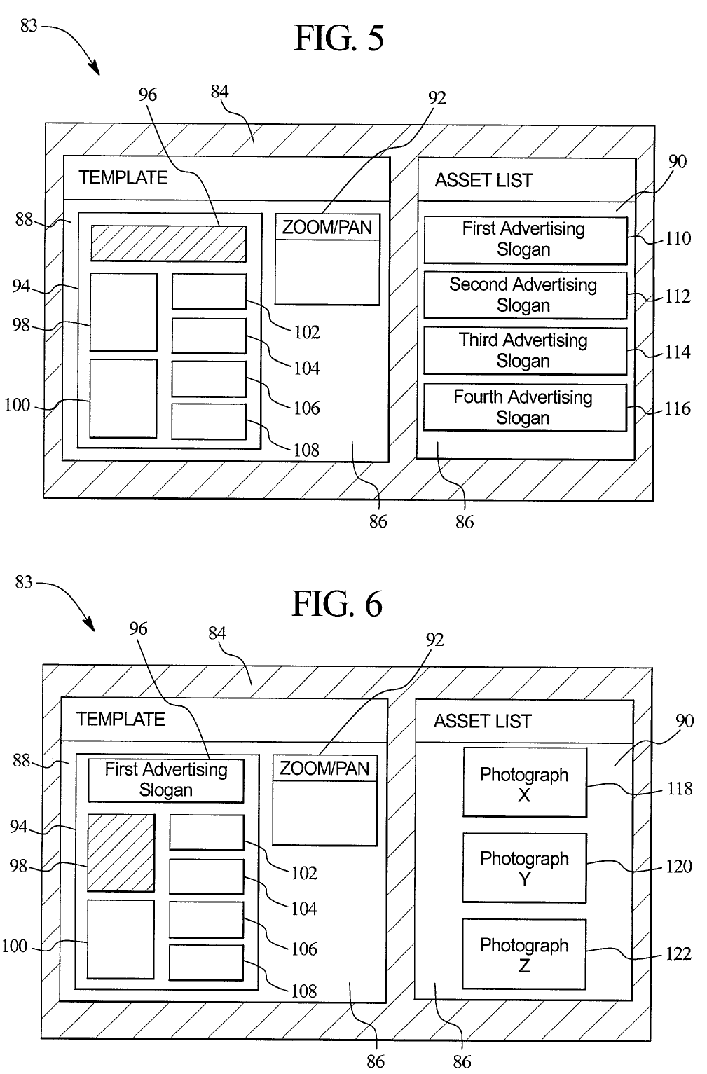

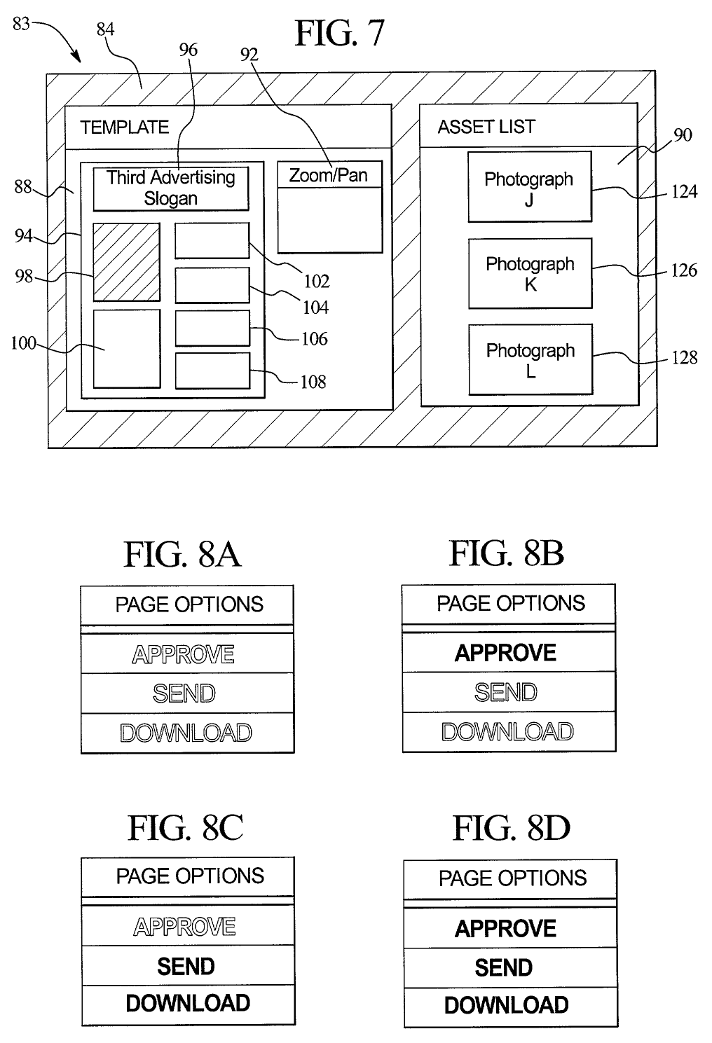

Each Asset Display Location of the template 94 may have different assets associated therewith. Thus, when a different Asset Display Location is selected, such as Asset Display Location 98, a different set of thumbnail assets will appear in the Asset Display Area 90. The set of assets that are displayed in the Asset Display Area 90 when a particular Asset Display Location is selected may be made dependent on an asset that has been selected for display in a different Asset Display Location. For example, assume that the assets available for display in Asset Display Location 98 are dependent on the selected contents of Asset Display Location 96. If, as shown in FIG. 6, the asset “First Advertising Slogan” 110 is selected to be displayed in Asset Display Location 96, a first set of thumbnail asset images, 118, 120, 122 comprising photograph X, photograph Y, and photograph Z respectively is displayed in the Asset Display Area 90 when Asset Display Location 98 is selected. If, on the other hand, the asset “Third Advertising Slogan” 114 was selected to be displayed in Asset Display Location 96 as shown in FIG. 7, a different set of thumbnail asset images 124, 126, 128 comprising photograph J, photograph K, and photograph L respectively are displayed in the Asset Display Area 90 when Asset Display Location 98 is selected. In this case, the Asset Display Location 98 is said to be dependent on Asset Display Location 96. Asset Display Location 96 is referred to as the parent Asset Display Location. Sets of available assets that are dependent upon other Asset Display Locations may contain the same or different assets. The system 30 can be configured such that, if the contents of a parent Asset Display Location are changed after an asset has already been selected in a dependent Asset Display Location, the asset in the dependent Asset Display Location will be reset. By creating parent and dependent Asset Display Locations, certain slogans can be tied to particular product photos and so forth.

A front-end user creates a marketing piece by selecting one-by-one each Asset Display Location and selecting an asset or entering and/or text to be displayed therein. When the marketing piece is complete, the front-end user may make the artwork available to the Company, or to an agent designated by the Company for approval. Alternatively, the front-end user may make the marketing piece available to a third party designated by the Dealer for review. Such third parties, whether designated by the Company or by the Dealer, may be independent advertising agencies or other marketing consultants with which the Company and/or the Dealer have relationships for implementing, managing, or otherwise assisting with marketing efforts.

The dynamic web page that is displayed by the user's web browser includes an “options” menu that lists a number of options available to the user. The options that are listed will depend on the specific template with which the user is working and where the user stands in the process of creating a new marketing piece. During the initial editing stage these options are displayed as not selectable. These options and their associated functions become available once assets have been selected for every Asset Display Location in the template. These options include an Approve option, a Send option and a Download option.

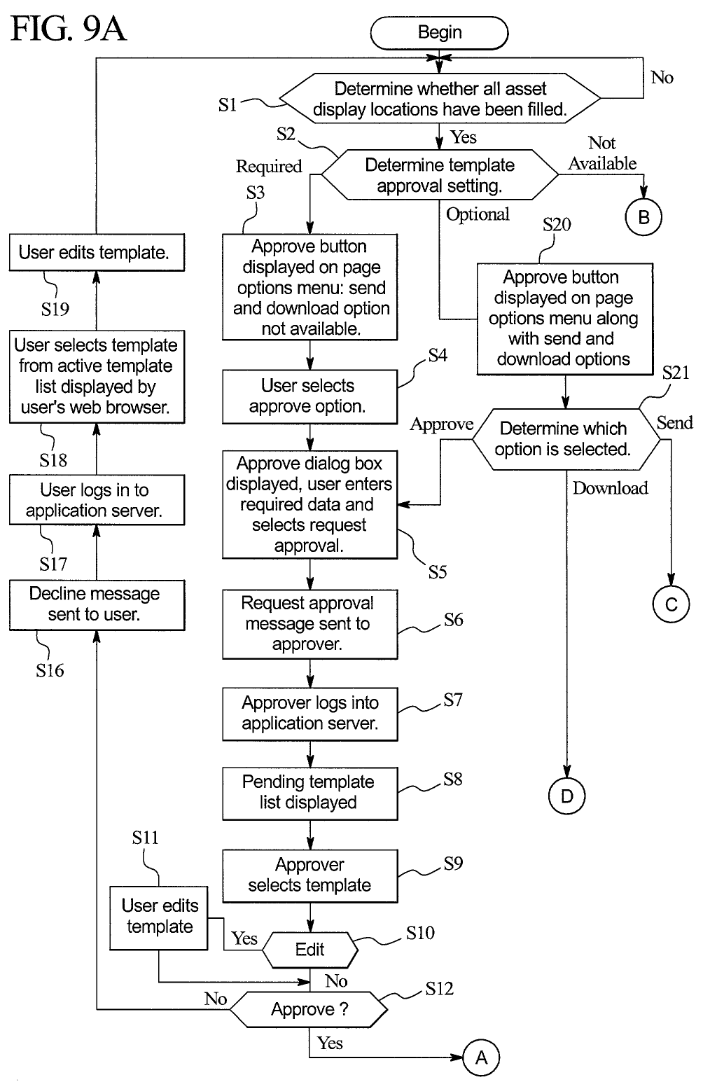

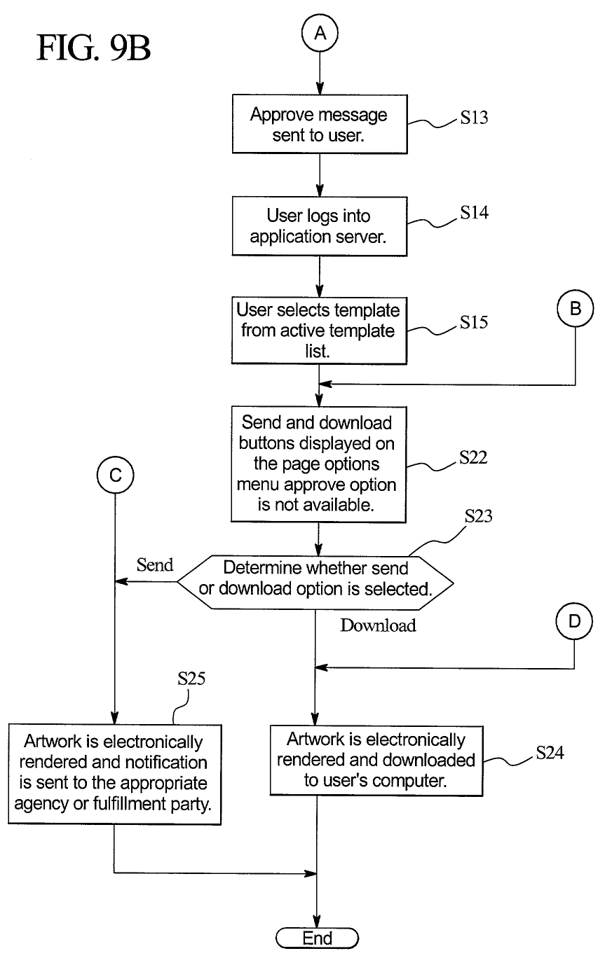

Approval requirements are set within each template. The flow chart of FIG. 9 sets out the various approval procedures that are enacted depending on the approval settings of the template. The process begins at step S1 where it is determined whether assets and/or text have been selected or entered for each of the required Asset Display Locations of the template. If not, the approval process cannot go forward. If the user attempts to send the template for approval, the page options menu will be displayed as illustrated in 8a where none of the options (Approve, Send, or Download) is selectable. Once all of the Asset Display Locations on the template have been filled, the process may move on to Step S2 where the approval setting of the template is evaluated. Approval may be “required,” “optional” or “not available”. If the approval setting of the template is set to “required” the process moves on to Step S3, where the Approve button is displayed in the page options menu of the web page displayed by the user's web browser, as illustrated in FIG. 8b. As shown in FIG. 8b, the Download and Send options are not selectable at this time because Approval is required, and as of yet, has not been granted.

When the front-end user selects the Approve button from the page options menu at Step S4, a dialog box is displayed by the front-end user's web browser in which the user is required to enter data regarding the marketing material, at Step S5. The information required from the user is determined by the Company's Distributed Brand Agreement and the type of marketing material being created. When the front-end user has finished entering the requested information the displayed dialog box, he or she selects the Approve button displayed therein. At Step S6, a message is sent to the party or parties designated as the approving authority by the Company user. The designation of an authorized approver is performed by a Company-user on the back-end when the template is created. Thus, an e-mail address or other means for contacting each approving authority is automatically associated with the template. When the front-end user selects the Request Approval button from the dialog box at Step S5, the application server 34 sends the Request Approval message to the approving authority via the designated communication method, such as e-mail. Upon receiving the request for approval message, the approver logs onto the application server 34 via the network 42 in Step S7. In order to log onto the application server, the approver must enter a valid username and password to access the system 30. At Step S8 a list of completed templates submitted to the approving authority is displayed by the approver's web browser, including the completed template submitted by the front-end user at Step S6. The approver selects the desired completed template from the list, and the template is displayed by the approver's web browser in Step S9. At Step S10 the approver can first determine whether or not the template requires editing. For example, the approver may see a typographical error or some other minor detail that he or she can fix on behalf of the Dealer user. If the approver elects to edit the template, the approver user is directed to an interface much like the front-end user uses to edit and create templates. Once the approver is done editing the template, or if he or she decides no editing is necessary, the approver may then determine whether or not to approve the submitted artwork at Step S12. Upon assigning approval or denial, an e-mail message is sent to the front-end user. If the template was approved, the user receives the approval message at Step S13 indicating the artwork's new status. Upon receiving this message, the front-end user again logs onto the application server 34 at Step S14, by entering the appropriate username and password. The front-end user may then select the artwork from the active items list displayed by the front-end user's web browser at Step S15. At Step S15 the page options menu is displayed on the front-end user's terminal with only the Download or Send options available as shown in FIG. 8c. The Approve option is not available, as the artwork has already been approved. The front-end user may then select one of these options at to complete the marketing piece.

If the approver does not approve the artwork at Step S12, however, a negative message is sent to the front-end user at Step S16. Additional comments may be included in the email notification informing the user why the artwork was not approved. The front-end user may them log back into the application server using his or her username and password at Step S17. Once logged in, the front-end user may then select the subject template from the Active items list displayed by the front-end user's web browser at Step S18. The front-end user may then edit the template at Step S19, deleting and changing assets, rewriting text, and so forth, in an attempt to create a marketing piece that will gain approval from the approving authority. Once the front-end user has finished editing the template he or she may resubmit the edited template for approval and the process is repeated until the artwork is approved.

Returning to Step S2, it may be determined that the approval of completed artwork is optional or not available at all.

If, it is determined at Step S2 that the template approval setting is set to “optional,” the approve option is displayed at Step S20 along with the send and download options in the page options menu for the web page displayed on the front-end user's web browser as shown in FIG. 8D. At Step S21 a determination is made as to which of the three options is selected. If the Approve option is selected the process moves to Step S5 where the entire approval process is executed in the same manner as previously described. If at Step S21 it is determined that send option is selected the process moves to Step S25 where the artwork is electronically rendered and notification is sent to the appropriate agency or fulfillment party. Otherwise, if at Step S21 it is determined that the download option was selected the process moves to Step S24 where the artwork is electronically rendered and downloaded to the user's computer.

Returning again to Step S2, if it is determined that the approval function is not available for the present template, the process flow moves directly to Step S23 where, as with the case after a template has been approved, the Send and Download options are displayed in the page options menu, but the Approve option is not available.

The Send or Download options may be selected after a template has been approved, if approval is required, or immediately after the template is completed if approval is optional or not available. If approval is optional, the send or download options may be selected at Step S21. If Approval is not available, or if the template has already been approved, Send or Download may be selected at Step S22. If the send option is selected, a notification is sent to the appropriate third party user (such as an ad agency, publisher or printer) for fulfillment. The third party user may then log onto the application server and render and download the electronic artwork. On the other hand, if Download is selected at either Step S21 or S23, the completed artwork is electronically rendered and downloaded to the front-end user's terminal 32, where it may be saved on an appropriate storage medium, and then displayed in its final, rendered form.

The systems responsible for generating and displaying the interactive dynamic web pages that are displayed on the front-end user terminal 32 the back-end user terminal 33, will now be described. Although different content is displayed on the user terminals of the various entities involved in creating marketing pieces using the system of the present invention, the process for generating and displaying the content is substantially the same for each user. Therefore, the present description will be limited to the dynamic content displayed on the front-end user terminal 32, knowing that the process is substantially the same for displaying content on the other terminals such as back-end user terminal 31 or third party user terminals.

The dynamic web pages are assembled and transmitted to the front-end user terminal 32 by the application server 34. The application server 34 receives content to be displayed in the pages or screens sent to the front-end user terminal from the animation generator. Due to the functional nature of the animation content generator 40, the content supplied is referred to as “movies” throughout this description. Although the displayed content is referred to as movies and is produced by animation software, the various elements displayed on the dynamic web pages sent to the front-end user terminal 32 are typically static. The term “movie” is a legacy of the animation software which is used in order to quickly update and load new images and objects into the display in a dynamic manner as the front-end user manipulates the images displayed on the front-end user terminal 32. By careful manipulation of the various animated movies and movie clips that are included for display within a dynamic web page, assets may be quickly retrieved and displayed so that the front-end user can quickly assemble and edit marketing materials. With the system 30 there is little delay between the selection of an Asset Display Location within a template and the display of all of the assets available to be inserted within the selected Asset Display Location. Similarly, there is little or no delay between the selection of an asset from the Asset Display Area 90 and its subsequent appearance in the corresponding Asset Display Location of the active template.

Generally speaking, the animation content generator 40 creates “screens” within the dynamic web pages that are assembled and downloaded by the application server 34 “screen” on which various animated movies are played. The actual content for the movies displayed by the animation software on the user's web browser is stored in the database 38 or is created by the animation content generator 40 based on data stored in the database. The animation software 41 creates a stack into which various movies are loaded for display within a dynamic web page generated by the application server 34. The stack forms a number of different levels for receiving movies. FIG. 3 shows a diagram of a stack 82 having levels 0 through 15. The animation content generator 40 assigns movies to different layers within the stack 82. Movies in different layers are displayed independently of one another and in an overlapping manner. Movies higher on the stack are displayed on top of those lower on the stack. Therefore, when multiple movies are in the stack, the movies higher in the stack are displayed in the foreground and those lower in the stack are displayed in the background. In addition to displaying movies on different layers, the animation content generator 40 can also cause movie clips to be displayed within movies already loaded into various layers of the stack, forming nested movies within movies.

According to a preferred embodiment of the present invention, when the system 30 is first launched, i.e. when a front-end user first logs into system 30 over the computer network 42, the animation content generator 40 loads a LOGIN movie into level 0 of the stack 82. The LOGIN movie causes a login screen to be displayed within the web page sent to the front-end user terminal 32. The LOGIN movie displayed on the user terminal prompts front-end user to enter his or her username or password into corresponding fields provided by the LOGIN movie, and sends the data back to the application server 34 for verification. After the front-end user has entered his or her username and password and the login procedure is successful, the LOGIN movie moves its play head to a blank gray screen that continues to be displayed. Any movies loaded thereafter into higher layers of the stack 82 will be displayed in front of the blank gray screen 84 as shown in FIGS. 4-7. Also following the successful completion of the login procedure, the LOGIN movie loads a HOMEPAGE movie into level three of the stack 82. The HOMEPAGE movie in turn loads three additional movies into higher levels of the stack 82: a HEADER movie is loaded into level 1, a SESSION TIMEOUT movie is loaded into level 15, and a PAGE OPTIONS movie is loaded into level 10. Once the HOMEPAGE movie has completed loading the HEADER, SESSION TIMEOUT, and PAGE OPTIONS movies, the contents of the stack 82 are as shown in FIG. 3. Among the items displayed by the HOMEPAGE movie are a number of drop down boxes that allow the front-end user to select a template or individual assets to be used in creating a new marketing piece.

A number of the movies that are displayed as part of the dynamic web pages displayed on the user terminal 12 include software objects that create virtual software buttons that may be activated by mouse clicking, or otherwise selecting the corresponding portion of the user interface associated with the software button. The software buttons include coded scripts that include commands to the application server 34 for manipulating the various templates and assets displayed on the user terminal 32. When a software button is activated its associated coded script is executed, and the command embodied in the script is communicated to the application server 34 over the network 42. The commands associated with the software buttons may include variable data so that the actions taken when the commands are executed reflect current conditions with regard to previous actions taken by the front-end user. Thus, when a front-end user selects a template identified in one of the HOMEPAGE drop down boxes and mouse clicks the software button provided to launch the desired template, the command to launch the template along with the template ID number of the desired template is sent to the application server 34.

When a template is selected from the drop down boxes displayed in the HOMEPAGE movie, the application server 34 sends an instruction to the animation software to load a LOADTEMPLATE into level 3 of the stack 82 replacing the HOMEPAGE movie.

The LOADTEMPLATE movie displays a bifurcated display area 86 over the blank gray screen 84 displayed by the LOGIN movie, the result of which is illustrated in FIG. 4. The display screen 86 includes the Template Display Area 88 and the Asset display area 90. A pan/zoom control object 92, the operation of which will be described later, is also displayed. Once the LOADTEMPLATE movie is loaded it opens a TEMPLATE movie clip within itself. Until this point, the movies displayed by the animation software are generic, and are loaded based on the permissions associated with the front-end user, the Dealer with whom the front-end user is associated, and the Company whose products are being advertised and whose Distributed Branding Program is being managed by the system 30. Therefore, the data for generating the LOGIN, HEADER, PAGEOPTIONS, TIMEOUT, and LOADTEMPLATE movies do not change from one front-end user to another. LOGIN, PAGEOPTIONS, and TIMEOUT, movies may therefore be stored directly on the application server. The application server may also request movies from the generator server such as, for example, the HEADER, HOMEPAGE and LOADTEMPLATE movies.

The TEMPLATE movie, and the movie clips to be displayed within the TEMPLATE movie, on the other hand, will be unique depending on the identity of the front-end user logged into system 30 and depending on which template the front-end user has selected. In this case, the data for creating the TEMPLATE movie and associated movie clips must be pulled from the database 38 via the application server 34 that communicates with the data base server 36. The TEMPLATE movie data and associated movie clip data are forwarded to the animation content generator 40 which generates the images that are to be displayed by the animation software running on the application server 34.

The particular TEMPLATE movie clip that is opened within the LOADTEMPLATE movie is determined when the front-end user selects a template from one of the drop down boxes displayed when the homepage movie is running and the associated software button is activated to launch the template. A template ID number identifying the desired template is included in the coded script executed when the software button for launching the template is selected. The template ID is received by the application server 34 along with the command to launch the TEMPLATE movie clip. If the template is being loaded from the History or Active files, the animation generator software 40 performs the task of loading images and text already associated with Asset Display Locations for the selected template.

The user terminal 32 sends the application server 34 the id of the template requested. The application server 34 then retrieves the name of the template movie from the database 38 via the database server 36. This information is sent to the user terminal 32 which, in turn, automatically asks the application server 34 to retrieve the movie for this template from the animation generator server 40. Once this TEMPLATE movie is loaded into LOADTEMPLATE, the TEMPLATE then requests its corresponding data from the application server 34. The TEMPLATE movie file contains data for displaying a visual representation of the desired template within the LOADTEMPLATE movie. This visual representation of the template is positioned within the LOADTEMPLATE movie according to coordinates defined within the LOADTEMPLATE movie. The TEMPLATE movie includes visual representation of the Asset Display Locations associated with the template. Each of the Asset Display Locations is displayed as a virtual software button that includes executable coded scripts that are executed when the front-end user selects a particular Asset Display Location. The executable scripts associated with the Asset Display Locations include a unique ID number for identifying the specific Asset Display Location with which the script is associated.

Tables within the database 38 list the assets associated with each Asset Display Location tied to pre-defined user groups or permissions. Similarly, other tables list various data files associated with each asset. In particular, each asset will have at least three associated image files. The first is a file containing a thumbnail image which is to be displayed in the Asset Display Area 90 when the Asset Display Location with which the asset is associated is selected. The second is a larger, medium resolution image file which is to be displayed within the template in the area defined by the Asset Display Location with which the asset is associated after the front-end user selects the asset to be displayed. Finally, a third image file associated with an asset will be a full-size high-resolution image of the asset to be employed when the finalized advertisement is rendered.

When the front-end user selects one of the Asset Display Locations of the template displayed in the LOADTEMPLATE movie as shown in FIG. 6, the assets associated with the selected Asset Display Location are to be displayed within the Asset Display Area 90. An example of this is shown in FIG. 5 where Asset Display Location 96 is shown as having been selected, and thumbnail assets 110, 112, 114 and 116 associated with Asset Display Location 96 are displayed in the Asset Display Area 90. The assets are displayed in the Asset Display Area by opening an ASSETDISPLAY movie clip within the LOADTEMPLATE movie. The position where the asset display movie is displayed, corresponding to the Asset Display Area 90, is determined by coordinates within the template load movie. Because the assets to be displayed within the asset display movie will vary depending on which Asset Display Location is selected and the user's groups or permissions settings, the process for generating and displaying the ASSETDISPLAY movie is more complex than the process for generating the template 94. The ASSETDISPLAY movie is dynamically generated based on the user's selection of the various Asset Display Locations.

When the front-end user selects a particular Asset Display Location such as Asset Display Location 96 for example, the coded script embedded within the selectable I.D. number sends a command to the application server to display the assets associated with the selected Asset Display Location. The application server 34 sends the Asset Display Location ID to the database server 36 which searches the database 38 for assets associated with the selected Asset Display Location that are appropriate to the user's permissions. The database server 36 returns a list of assets, including the asset ID numbers and asset names of assets associated with the selected Asset Display Location to the application server 34. The application server 34 then commands the animation content generator 40 to create an ASSETDISPLAY movie clip that is to be played within the LOADTEMPLATE movie in a position corresponding to the Asset Display Area 90. Among the data sent from the application server 34 to the animation content generator 40 are a list of the asset ID numbers of the assets that are to be included in the ASSETDISPLAY movie, and the address of the image files (such as JPEG's, for example) that contain the thumbnail images of the identified assets. The animation content generator 40 uses two generator objects for each asset that is to be included in the ASSETDISPLAY movie, a list object and an insert asset object of an image file type such as JPEG. The list objects receive data for creating a software button within the asset display movie corresponding to their respective assets. The data received into the list object are incorporated into command scripts that are executed when the virtual software button created by the list object is activated. The data supplied from the database 38 through the application server may contain the asset name, the asset ID number, the address of the image file for display in the Asset Display Location should the asset be selected for inclusion in the advertisement, the asset ID of the high resolution image file for rendering the asset when the ad is rendered, as well as the ID number of the Asset Display Location with which the asset is associated.

The insert JPEG objects receive the thumbnail JPEG (or some other image format) image files of each asset to be displayed in the asset display movie. The animation content generator 40 creates the asset display movie with the thumbnail JPEG image files of each insert JPEG object displayed above the corresponding list asset object. Thus, when the ASSETDISPLAY movie is displayed, the software buttons corresponding to the list asset objects may be activated by mouse clicking the overlaying thumbnail images of the asset. The animation content generator 40 arranges the set of list asset objects and insert JPEG objects associated with the selected Asset Display Location vertically in spaced intervals according to predetermined rules. Once the animation content generator 40 has assembled the ASSETDISPLAY movie, the application server 34 sends an instruction to the animation software directing the animation software to open the ASSETDISPLAY movie within the LOADTEMPLATE movie. The application server formulates the data source (all data necessary to generate the ASSETDISPLAY movie) and attaches it to the beginning of a URL that references the content generator 40. The application server passes that back to the animation display software 41, which automatically makes a call to load that URL. Once the generator server gets the request for the ASSETDISPLAY movie, it asks the application server to interpret the data source. Thus, thumbnail images of the assets available to be selected for display within the selected Asset Display Location are displayed within the Asset Display Area 90 when the various Asset Display Locations are selected.

A similar process occurs when an asset displayed in the Asset Display Area is selected to be displayed within the selected Asset Display Location. Mouse clicking or otherwise selecting one of the thumbnail images displayed in the Asset Display Area 90 executes the coded script embedded within the list asset object associated with the selected asset. The executed script includes the address of the JPEG (or some other image format) image to be displayed in the template in the place of the selected Asset Display Location. The executed script also includes the id of the high-resolution image file to be used in rendering the completed advertisement. The application server 34 pulls the template display JPEG image from the database 38 and instructs the animation content generator 40 to create an asset movie clip incorporating the corresponding template display JPEG image. The application server also sends a command to the animation software 41 identifying the next action to be taken, namely, loading the asset movie clip of the template display JPEG image into the TEMPLATE movie. Upon loading the template display JPEG image movie clip into the template movie, the animation software causes the JPEG image of the selected asset to be displayed at a position within the template corresponding to the outline of the corresponding Asset Display Location. Thus, an asset may be selected from the Asset Display Area 90 and the corresponding image displayed in the appropriate Asset Display Location in the template 94.

A further level of nesting display data may be included in an asset selected for display within an Asset Display Location. For example, a selected asset may include text describing product prices, wherein the actual prices may be set by the Dealer. Thus, the text describing the products is standard and unchangeable within the particular asset, but the price is variable. In this case, the asset movie created and displayed within the selectable area is created with its own sub-Asset Display Location that is displayed when the asset is displayed within the selected pre-defined Asset Display Location. When the front-end user selects such a sub-Asset Display Location another ASSETDISPLAY movie clip must be created for displaying the assets that may be selected to be displayed within the sub-Asset Display Location. This process mirrors the process for generating the ASSETDISPLAY movie when the Asset Display Location is selected, except that rather than displaying additional assets in the Asset Display Area 90, a text box is generated, and the front-end user may enter text directly. Upon entering the appropriate text within the text box, the front-end user may select a software virtual button created within the ASSETDISPLAY movie to have the text appear within the asset displayed within the selected Asset Display Location. The added text will become part of the completed ad.

As assets are selected for the various Asset Display Locations, the animation display software running on the user's browser maintains a record of the assets assigned to each Asset Display Location in the template. A data string is generated for each Asset Display Location. This string includes the position of the corresponding Asset Display Location, the height and width of the Asset Display Location, and the address of the high-resolution image file of the asset selected for the Asset Display Location. The data strings for each Asset Display Location are concatenated to form a single string that defines the contents of the entire ad. This long string of data represents the completed ad in its entirety, and may be saved on the database 38.

When the template is complete and if approval is required has been approved by the proper approving authority, the completed artwork may be electronically rendered. The electronic rendering process converts the completed template into a single flattened file or a more complex file or collection of files, which contains all of the selected assets in the proper locations at that proper size and resolution. More complex renderings more easily facilitate the production of higher quality image and text reproduction. Each asset selected for the final artwork is formatted for the corresponding Asset Display Location for which it is selected. A single graphical output file (.TIFF, .JPEG, .SWF, .AI, .PDF, etc.), suitable for producing publishable images, is generated by mapping the various attributes of the selected assets to each pixel of the final advertisement. These file types accommodate different reproduction needs or environments. For example, a particular Asset Display Location may be located at a position (x, y, z) within the template. Further, the Asset Display Location may occupy a 2″×3″ space in a template corresponding to an 8½×11″ sheet. Thus, the individual pixels of the final rendered advertisement that correspond to the asset displayed in the Asset Display Location may be determined from the position and size of the Asset Display Location. The graphical elements of the assets may then be mapped to the corresponding pixels. Rendering open text and database-populated text Asset Display Locations requires an additional step. When such Asset Display Locations are created they are assigned a number of attributes such as font face, font size, maximum size, and so forth. These attributes define how the text entered by the user will be presented within the Asset Display Location. When the text is entered into the Asset Display Location, either by the user in the case of open text Asset Display Locations or from the database in the case of database populated text Asset Display Locations, the attributes are applied and the resulting text image is converted to an image file (such as JPEG) by the generator server. The JPEG image of the entered text is then rendered in the same manner as any other graphical asset.

By mapping elements of the assets to the corresponding pixels, the necessary content of each pixel for the entire artwork may be defined, and the corresponding graphical output file created. Once the fully rendered graphical output file has been created, it may be easily transmitted over a computer network such as the Internet. Thus the rendered graphical output file can be sent directly to the party fulfilling the order, be it a webmaster, publisher, individual printer, or the like. The graphical output file may be imported directed into printing software applications to further facilitate the final preparation of the ad.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of managing a Distributed Branding Program comprising the steps of:
storing a plurality of assets in a database;
creating a template having one or more predefined areas selectable by a user for displaying assets;
forming associations between said assets and said one or more Asset Display Locations;
selecting one of said one or more Asset Display Locations; and
selecting an asset from among a group of said assets formed of those assets having an association with the selected one of the one or more Asset Display Locations; and
creating an advertisement corresponding to said template wherein a representation of said selected asset appears in an area corresponding to said selected Asset Display Location.

2. The method of claim 1 wherein the step of creating a template comprises creating a plurality of said templates and wherein the method further includes the step of designating specific users having access to each individual template.

3. The method of claim 1 wherein the template, the assets, and the association formed between the assets and the at least one predefined area of the template are created in compliance with a Distributed Branding Agreement such that the marketing material created corresponding to the template meets requirements established by said agreement.

4. The method of claim 1 further comprising the steps of:
providing an application server having access to the database;
establishing a connection between application server and a user terminal via a computer network; and
transmitting the template to the user terminal over the network for display on the user terminal.

5. The method of claim 4 further comprising the steps of:
receiving input data at the application server indicating that a particular one of said one or more Asset Display Locations has been selected;
retrieving said group of assets having an association with the selected Asset Display Location from the database; and
transmitting said group of assets to the user terminal for display.

6. The method of claim 5 further comprising the steps of:
receiving data at the application server indicating that a particular one of said assets has been selected from the group of assets having an association with the selected Asset Display Location; and
causing an image of said selected asset to be displayed within the template transmitted to the user terminal at a location corresponding to said selected Asset Display Location.

7. The method of claim 6 wherein the step of causing an image of said selected asset to be displayed within the template transmitted to the user terminal includes causing a selectable sub-area to be displayed within the image of said selected assets.

8. The method of claim 1 wherein at least one of said assets comprises an image.

9. The method of claim 1 wherein at least one of said assets comprises predefined text.

10. The method of claim 1 wherein at least one of said Asset Display Locations comprises an open text box wherein a user may enter user-selected text.

11. The method of claim 1 wherein at least one of said Asset Display Locations comprises a database populated text Asset Display Location wherein default text having one or more portions that may be overwritten with text entered by a user.

12. A system for managing a Distributed Branding Program comprising:
a database having a plurality of templates and assets stored thereon, said templates having Asset Display Locations configured to receive and display assets;
an application server configured to retrieve said templates and said assets from said database and to communicate with a user terminal over a computer network to selectively display said templates and said assets in response to user input entered at said user terminal.

13. The system of claim 12 further comprising animation software for displaying dynamic content on display pages transmitted to said use terminal from said application server, and a animation content generator for generating said dynamic content.

14. A method for creating marketing materials comprising the steps of:
selecting a template having one or more Asset Display Locations;
selecting one of the one or more Asset Display Locations;
selecting an asset from a group of assets associated with the selected Asset Display Location;
displaying the selected asset in the selected template in an area corresponding to the selected one or more Asset Display Locations; and
electronically rendering an advertisement based on the selected template and the selected asset and text.

15. The method and claim 14 further comprising the step of creating a template and storing the template in a database.

16. The method of claim 15 further comprising the steps of:
defining Asset Display Locations within said template and identifying specific assets that may be displayed in said Asset Display Locations.

17. The method of claim 16 further comprising the step of restricting access to said template to a select group of users.

18. The method of claim 17 further comprising the step of displaying said template on a user terminal.

19. The method of claim 18 further comprising the step of displaying said group of assets associated with the selected Asset Display Location on said user terminal.

20. The method of claim 19 further comprising the step of displaying the selected asset on said user terminal within the selected Asset Display Location.

21. The method of claim 14 further comprising the step of displaying said template on a user terminal.

22. The method of claim 21 further comprising the step of displaying said group of assets associated with the selected Asset Display Location on said user terminal.

23. The method of claim 22 further comprising the step of selecting an asset from said group of assets and displaying the selected asset on said user terminal within the selected Asset Display Location.

24. A method for creating marketing materials comprising the steps of:
Selecting a template having one or more Asset Display Locations;
Pre-populating one of said Asset Display Locations with data stored in a database;
Displaying the data in the template in an area corresponding to the location of the pre-populated Asset Display Location; and
Electronically rendering an advertisement based on the selected template and the data pre-populating the Asset Display Location.

25. The method of claim 24 further comprising the step of editing the data pre-populating the Asset Display Location.

26. A method for creating marketing materials comprising the steps of:
selecting a template having one or more Asset Display Locations;
selecting one or more Asset Display Locations;
entering text to be displayed in the template in an area corresponding to the selected one ore more Asset Display Locations; and
Electronically rendering marketing materials based on the selected template and the entered text.

27. A system for creating marketing materials comprising:
an application server for receiving input from and displaying information on a user terminal via a network;
a database having a plurality templates and assets stored therein, the templates having Asset Display Locations for receiving assets, each Asset Display Location having at least one asset associated there with;
said application server configured to retrieve a template from said database in response to user input received from the user terminal and transmit the template to the user terminal for display via the network;
the application server also configured to receive input from the user terminal indicating the selection of an Asset Display Location, and to retrieve the assets stored in the database associated with said selected Asset Display Location, and transmit said assets to the user terminal for display via the network;
the application server further configured to receive an indication from the user terminal of an asset selection, the application server causing the user terminal to display the selected asset within the selected area, and
in response to a rendering command from the user terminal the application server electronically rendering an advertisement according to the selected template, the selected Asset Display Location and the selected asset.

28. The system of claim 26 further comprising animation software and an animation content generator associated with the application server for generating and displaying template and asset images to be transmitted by the application server to the user terminal for display.

29. The system of claim 26 wherein at least one of said assets comprises an image.

30. The system of claim 26 wherein at least one of said assets comprises predefined text.

31. The system of claim 26 wherein at least one of said Asset Display Locations comprises an open text box wherein a user may enter user-selected text.

32. The system of claim 26 wherein at least one of said Asset Display Locations comprises predefined text having one or more portions that may be overwritten by text entered by a user.

33. A dynamic web page for creating marketing materials which meet guidelines established in a Distributed Branding Agreement, the dynamic web page adapted to be displayed on a computer output device and comprising:
a Template Display Area;
a template displayable within the Template Display Area having one or more Asset Display Locations for receiving and displaying advertising content; and
an Asset Display Area for displaying selectable advertising content in the form of individual selectable assets associated with a selected one of said Asset Display Locations, the assets displayed depending on which Asset Display Location is selected; and
wherein an asset selected from the Asset Display Area is displayed in the Template Display Area in a location corresponding to the selected Asset Display Location.
